(19) United States
(12) Patent Application Publication
(10) Pub. No.: US 2015/0076853 A1
(43) Pub. Date: Mar. 19, 2015

(54) Retaining device for fastening an electronic device in a motor vehicle

(71) Applicant: Bury Sp.z.o.o, Mielec (PL)

(72) Inventors: Krzysztof Skolimowski, Chorzelow (PL); Jacek Brzana, Rowne (PL)

(73) Assignee: Bury Sp.z.o.o, Mielec (PL)

(21) Appl. No.: 14/182,433

(22) Filed: Feb. 18, 2014

(30) Foreign Application Priority Data
Sep. 19, 2013 (DE) 10 2013 015 490.1

(51) Int. Cl. B60R 11/02; E05B 47/00

(52) U.S. Cl. CPC B60R 11/02; E05B 47/0038; B60R 2011/0015
USPC 296/63; 296/37.8

(57) ABSTRACT

The invention relates to a retaining device for fastening an electronic device in a motor vehicle, wherein the retaining device comprises
a receiving device (30) for receiving the electronic device and
a retainer with a shaft (4) for inserting a part of the receiving device (30),
wherein the retainer comprises
a flap (6) closing the shaft (4),
a first interactive element (28) and
at least one locking bar element (10),
which is able to be moved into at least one closed position in which it prevents a movement of the flap (6)
and is able to be moved into an open position in which it does not prevent a movement of the flap (6),
wherein the receiving device (30) has a second interactive element (32),
wherein the first interactive element (28) and/or the second interactive element (32) has a permanent magnet and
wherein the at least one locking bar element (10) is able to be moved from the closed position into the open position, by the first interactive element (28) and the second interactive element (32) being brought together.

The invention relates to a retaining device for fastening an electronic device in a motor vehicle. Many electronic devices which are configured to be portable are used nowadays in motor vehicles, for example during the journey. This not only relates to electronic devices which are operated by the driver of the respective motor vehicle during the journey, such as for example portable navigation devices or telecommunication devices, such as for example smartphones or mobile radio devices. Also, other passengers in a motor vehicle, such as for example the front-seat passenger or passengers on the rear vehicle seats, may use a wide variety of electronic devices in many different applications. Mobile telecommunication devices, such as for example smartphones, mobile telephones or tablet PCs and also electronic entertainment devices, such as for example portable DVD players or similar devices are relevant devices here. In particular on the rear seat bench, this is important for children, in order to provide entertainment, in particular on long journeys.

In order to fasten such electronic devices in the respectively required positions in the motor vehicle, a series of different retaining devices are known from the prior art. Portable navigation devices are often fastened, for example, by a suction cup to the front windshield of the motor vehicle, whereby often only insufficient stability is achieved however and also unattractive edges of the suction cup remain on the front windshield when the suction cup has been dismantled.

Retainers are known for fastening an electronic device so that it is able to be operated from the rear seat bench of the motor vehicle, said retainers being arranged for example on the struts of the head restraint of the driver's seat and/or the front-seat passenger's seat. A drawback is that said retrospectively arranged retaining devices have a negative impact on the interior of the motor vehicle which is often designed in great detail from an aesthetic point of view and are clearly visible from the outside when no electronic device is fastened thereto. Specifically in this case there is the risk that, in particular, children who are sitting on the rear seat bench of the motor vehicle play with the empty retainer which is not provided with an electronic device and thus damage, for example, sensitive components, such as for example interfaces for the data connection with the electronic device or become caught on clamping devices provided for the retainer of the electronic device.

The object of the invention, therefore, is to develop a retaining device for fastening an electronic device in a motor vehicle, such that a simple and secure fastening of the electronic device is ensured, the overall aesthetic appearance of the interior is impaired as little as possible and at the same time the risk of injury or the risk of damage to the retainer by children is reduced.

The invention achieves the object set forth by a retaining device for fastening an electronic device in a motor vehicle, wherein the retaining device has a receiving device for receiving the electronic device and a retainer with a shaft for inserting a part of the receiving device, wherein the retainer has a flap closing the shaft, a first interactive element and at least one locking bar element which is able to be moved into at least one closed position in which it prevents a movement of the flap and is able to be moved into an open position in which it does not prevent a movement of the flap, wherein the receiving device has a second interactive element, wherein the first interactive element and/or the second interactive element has a permanent magnet and wherein the at least one locking bar element is able to be moved from the closed position into the open position, by the interactive element and the second interactive element being brought together.

As a result, the retaining device according to the invention comprises two separate elements. The electronic device is arranged in the receiving device. Said receiving device may have retaining elements provided therefor, the spacing thereof being able to be adjusted, for example, to the length and/or the width of the electronic device, as is known from the prior art. As a result, the electronic device is secured in the receiving device to prevent slipping, so that said device is not able to be removed from the receiving device by vibrations and forces occurring during the journey. In this case, interfaces for data and/or electrical connections may be additionally present so that the electronic device may use, for example, a hands-free device or other devices of the motor vehicle and/or an existing rechargeable battery of the electronic device may be charged up during the journey.

The retainer of the retaining device is advantageously fixedly arranged in the motor vehicle. This may be implemented at very different locations in the interior, wherein for example the dashboard, in particular on the front-seat passenger's side, the central console, a door trim, or the backrest of a motor vehicle are suitable locations. Depending on the desired alignment and position of the electronic device, however, other positions are also conceivable for the retainer. The retainer itself has a shaft in which part of the receiving device, in which the electronic device is received, is inserted. As a result, the receiving device and thus also the electronic device received therein are arranged fixedly and securely in the interior of the motor vehicle.

In order to prevent, for example, children becoming injured or inserting unwanted objects into the shaft when playing on or with the shaft, the shaft is closed by a flap. By the visual styling and the design of said flap, the influence of the retaining device on the overall aesthetic appearance of the interior of the motor vehicle may be additionally minimized or, if desired, a visual feature may be provided. The retainer additionally has a locking bar element which is able to be moved into a closed position and into an open position. If the locking bar element is in the closed position, the flap is not able to be moved and accordingly the shaft is not able to be opened. This is expedient, in particular, in the case where no receiving device is to be introduced into the shaft and no electronic device has to be fastened in the motor vehicle. However, in this case the retainer with the shaft remains installed in the motor vehicle. In this case, the shaft is not intended to be accessible so that the locking bar element is in the closed position and the flap is therefore not able to be moved.

If, however, part of the receiving device is to be inserted into the shaft, the flap has to be moved in order to open the shaft. Thus, the locking bar element is able to be moved into an open position in which it does not prevent the movement of the flap.

The retainer has a first interactive element and the receiving device has a second interactive element. At least one of said two interactive elements is configured as a permanent magnet. The respective other interactive element is configured in this case so that bringing the two interactive elements together ensures that the locking bar element is moved from the closed position into the open position.

Advantageously, the second interactive element is located on the part of the receiving device which is intended to be inserted into the shaft. If in this case the first interactive element is arranged in the vicinity of the flap, it automatically leads to the bringing-together of the two interactive elements if the part of the receiving device is to be inserted into the shaft. In this manner, a separate operating element or an additional movement by the person who wishes to fasten the electronic device in the motor vehicle is not necessary.

Preferably, the first interactive element or the second interactive element consist at least partially of a magnetizable material, in particular a paramagnetic or ferromagnetic material. As the respective other interactive element has a permanent magnet, it results in this case in a magnetic force which acts on the two interactive elements when they are brought together. By means of this force, the locking bar element is moved from the closed position into the open position.

It has proved particularly advantageous here if the first interactive element which is located on the retainer at least partially consists of the paramagnetic or ferromagnetic material. In this manner, it is ensured that the flap is only able to be opened by the receiving device of the retaining device on which the second interactive element is located. If the first interactive element consists at least partially of a paramagnetic material, the second interactive element has to comprise the permanent magnet so that when the two interactive elements are brought together it results in a magnetic force. Naturally, it is also possible to configure the first interactive element as a permanent magnet and to produce the second interactive element which is located on the receiving device at least partially from a paramagnetic or ferromagnetic material. In this case, however, the flap could also be opened by any other object which consists at least partially of a paramagnetic material, which may not be desirable.

If both the first interactive element and the second interactive element have a permanent magnet, it is advantageous to arrange the two interactive elements in the receiving device and/or on the retainer, so that when bringing together the two interactive elements, a attracting force is produced. In this manner, a particularly simple mechanical design of the locking bar element may be achieved. Naturally, a design is also possible in which the two permanent magnets are arranged in the two interactive elements so that when the two interactive elements are brought together, a repelling force is produced.

Advantageously, the at least one locking bar element is spring-loaded in the direction of the closed position. If, as a result, by bringing together the two interactive elements, the locking bar element is moved from the closed position into the open position and subsequently the first interactive element is again moved away from the second interactive element, by for example the receiving device being removed from the shaft, the spring-loading of the locking bar element ensures that the flap, which is preferably also spring-loaded and is pushed again in front of the opening of the shaft, is no longer able to be moved. A separate additional locking or closing of the flap is not necessary in this case.

A particularly simple embodiment has proved advantageous when the first interactive element is arranged on a movably mounted carrier element which is arranged so that it moves the at least one locking bar element from the closed position into the open position when the first interactive element and the second interactive element are brought together. By means of the force which is exerted by the two interactive elements on one another the carrier element is consequently moved and in this manner the locking bar element moves from the closed position into the open position.

In this case, it is advantageous if the carrier element is arranged on a side of the flap facing the shaft. This has the result that the required components, for example the spring element, joint, hinges or the like may be arranged on the inside of the flap which faces the shaft. On the side of the flap remote from the shaft, which is visible from the outside, by the design of the flap the overall visual impression may thus be produced as desired without the components which are required for the function of the retaining device being visible.

Advantageously, at least one interface element is arranged in each case on the part of the receiving device which is able to be inserted into the shaft and in the shaft, such that the two interface elements come into contact with one another when the part of the receiving device is inserted into the shaft. Preferably, the interface element which is located in the shaft of the retainer is connected, for example, to the on-board electronics system or the electrical supply system of the motor vehicle. In this manner, when bringing the two interface elements into contact, it may be achieved that, for example, a rechargeable battery of an electronic device received in the receiving device may be charged up. Also, a data connection may be established in this manner, so that for example hands-free devices also present in the motor vehicle may be used by the electronic device which is received in the receiving device of the retaining device.

The interface elements may in this case be arranged, for example, on a side wall of the shaft and a corresponding side wall of the part of the receiving device, so that when inserting the receiving device into the shaft it results in sliding contact between the interfaces. Alternatively or additionally, interface elements may also be present, said interface elements being configured as a corresponding plug and socket and being interlocked when inserting the part of the receiving device into the shaft.

Preferably, the receiving device has at least one interface for producing an electrical connection and/or a data connection with the electronic device.

The invention solves the object set forth by a retainer for a retaining device described here as well as by a motor vehicle comprising a retainer for such a retaining device. The retainer is in this case particularly preferably arranged in the backrest of a motor vehicle seat. As already set forth, naturally the retainer may also be arranged at different locations, such as for example the door trim, a storage compartment arranged between two motor vehicle seats, for example in the rear seat bench or the roof lining.

An exemplary embodiment of the present invention is described in more detail hereinafter with reference to the drawings, in which:

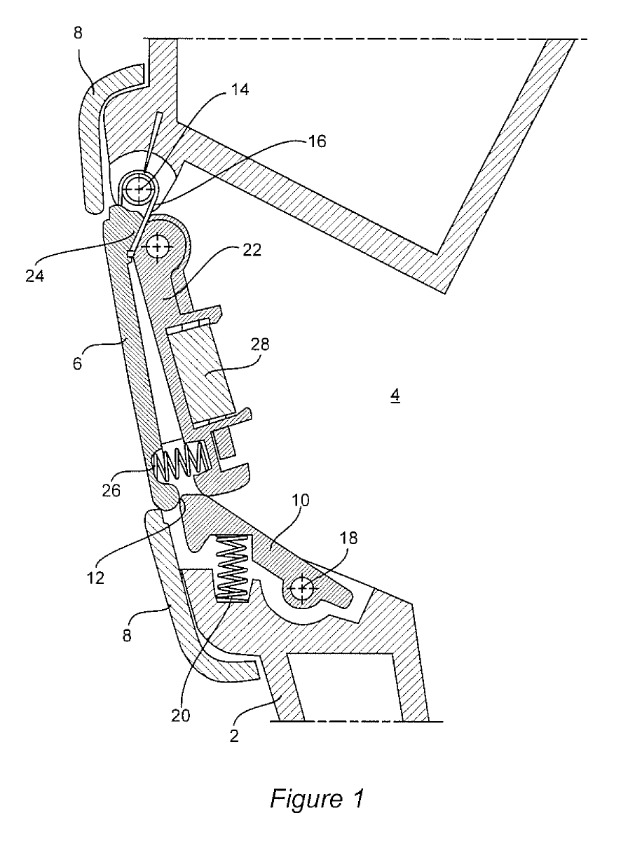

FIG. 1 shows a schematic sectional view through part of a retainer of a retaining device according to a first exemplary embodiment of the present invention,

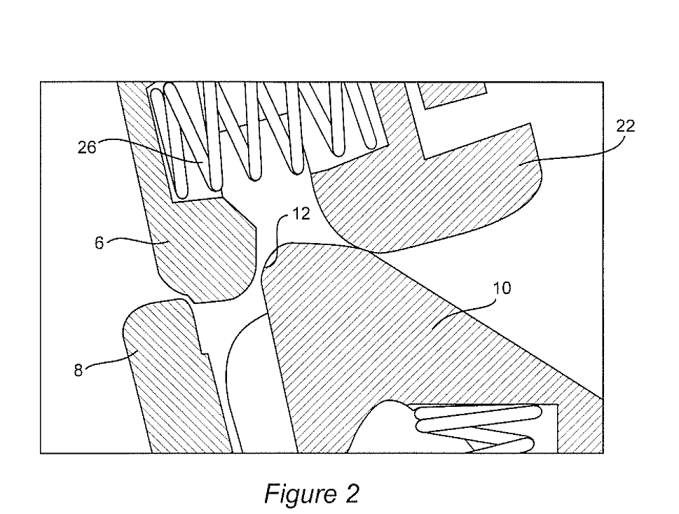

FIG. 2 shows an enlarged detail of FIG. 1,

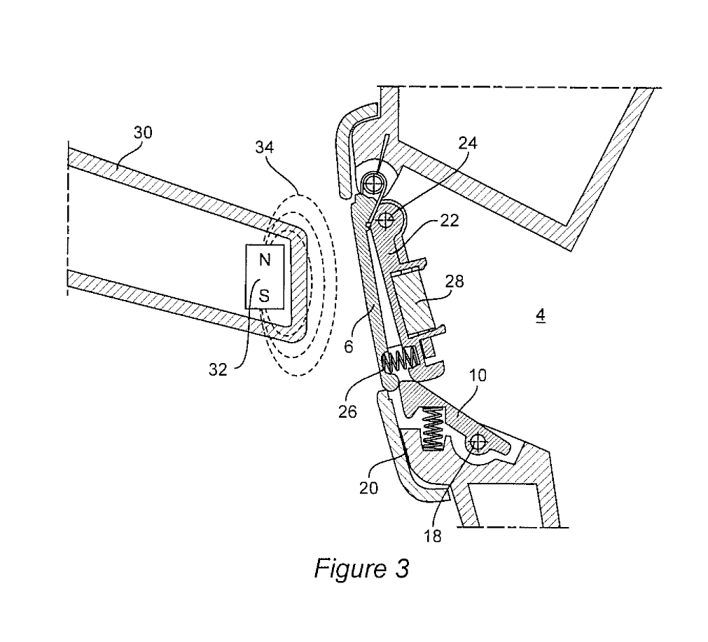

FIG. 3 shows the schematic sectional view through a retainer and a part of a receiving device of a retaining device according to a further exemplary embodiment of the present invention,

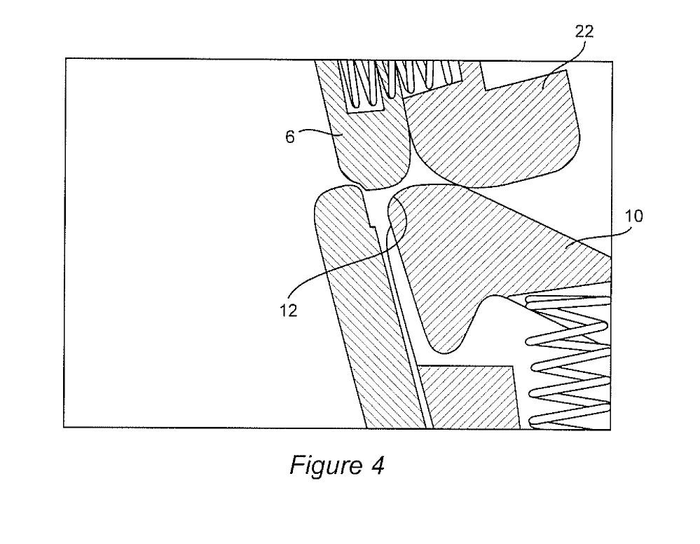

FIG. 4 shows an enlarged detail of FIG. 3 and

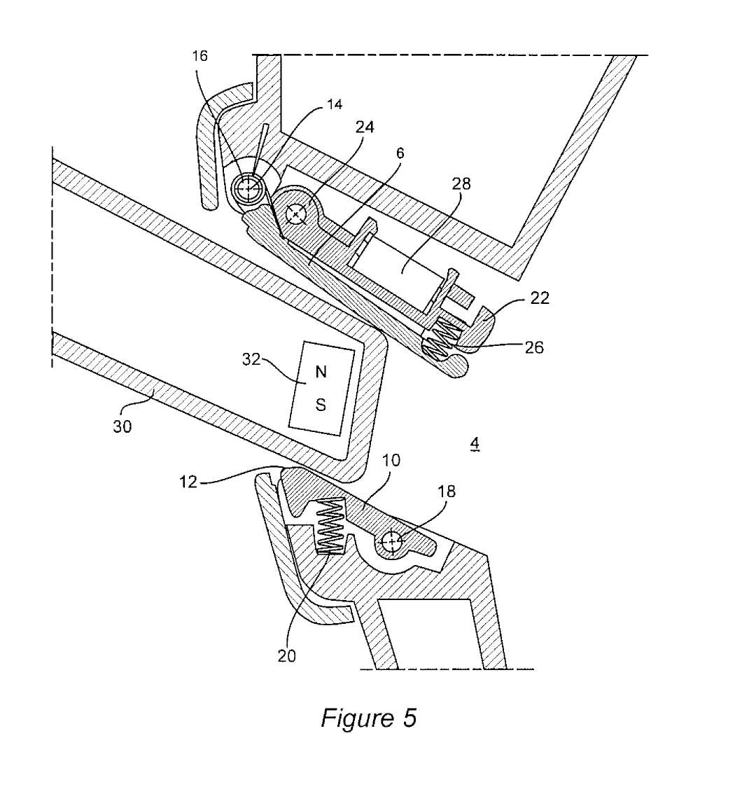

FIG. 5 shows a schematic sectional view through a retainer with the receiving device inserted.

FIG. 1 shows a sectional view through a retainer which in this case is arranged in a backrest 2 of a motor vehicle. The retainer has a schematically indicated shaft 4 which is closed by a flap 6. The inserted retainer is covered by a cover plate 8 by which the visual appearance of the backrest 2 may be determined.

A locking bar element 10, which in the state shown in FIG. 1 is located in the closed position, is located in the lower region of the retainer. The locking bar element 10 has a contact edge 12 which in the state shown bears against the flap 6 and thus prevents a movement of the flap 6 into the interior of the shaft 4, i.e. in FIG. 1 to the right. The flap 6 is pivotably mounted about a flap axis 14, wherein a corresponding pivoting movement of the flap 6 about the flap axis 14 is spring-loaded by a flap spring 16, by which the flap 6 is pretensioned into the position shown in FIG. 1. The flap spring 16 in this case may be configured in any suitable embodiment of a spring element integrated in the flap 6.

The locking bar element 10 is pivotably mounted about a locking bar axis 18 and pretensioned by a locking bar spring 20 into the closed position shown in FIG. 1.

A carrier element 22 is located on the side of the flap facing the shaft 4, said carrier element being pivotably fastened to the flap 6 about the carrier axis 24. The corresponding pivoting movement of the carrier element 22 about the carrier axis 24 is spring-loaded by a carrier spring 26. The carrier element 22 carries a first interactive element 28 which advantageously consists of a paramagnetic or ferromagnetic material.

As a result, in the state shown in FIG. 1, it is not possible without aids to force the flap 6 into the shaft 4 from the outside and thus to open the shaft in order to insert, for example, objects into the shaft 4.

FIG. 2 shows an enlarged detail of FIG. 1. The locking bar element 10 with the contact edge 12 is visible, said locking bar element in the state shown in FIG. 2 virtually bearing against the flap 6 and thus only permitting a minimal movement of the flap 6 in FIG. 2 to the right. Naturally, it is also possible to configure the locking bar element 10 so that the flap 6 bears against the contact edge 12 of the locking bar element 10. The carrier element 22 which carries the first interactive element 28, not shown in FIG. 2, bears against the locking bar element 10.

FIG. 3 shows the retainer of FIG. 1, a part of a receiving device 30 which is intended to be inserted into the shaft 4 being moved toward said retainer. The shape of the part of the receiving device 30 is adapted to the shape of the shaft 4. A second interactive element 32 is located in the right-hand region of the receiving device 30, said second interactive element being configured in the exemplary embodiment shown in FIG. 3 as a permanent magnet. This is shown by the schematically shown north pole (N) and south pole (S). Magnetic field lines are shown schematically as dashed lines 34 which, however, are only intended to illustrate that the permanent magnet which forms the second interactive element 32 has a magnetic field.

By this magnetic field, an attracting force is exerted on the first interactive element 28 in the exemplary embodiment shown in FIG. 3, so that the first interactive element 28 and thus also the carrier element 22 are moved toward the second interactive element 32. It may be seen that in comparison with FIG. 1 the carrier spring 26 has been compressed and the carrier element 22 has been pivoted about the carrier axis 24. The flap 6 has not yet been moved.

As shown in FIG. 2, the carrier element 22 bears against the locking bar element 10. By the interaction between the first interactive element 28 and the second interactive element 32, the carrier element 22 is now moved and in this manner also displaces the locking bar element 10. The locking bar element 10 in this case is displaced about the locking bar axis 18 and the locking bar spring 20 is compressed.

FIG. 4 shows an enlarged detail of FIG. 3. In comparison with FIG. 2 it may be seen that the locking bar element 10 has been pivoted by the carrier element 22 downward and/or about the locking bar axis 18. This has the result that the contact edge 12 of the locking bar element 10 no longer hinders a movement of the flap 6. As a result, the flap 6 may now be pivoted about the flap axis 14 and moved into the interior of the shaft. As a result, the locking bar element 10 is located in FIGS. 3 and 4 in the open position in which the locking bar element 10 does not prevent a movement of the flap 6.

In FIG. 5 it is shown that the receiving device 30 may now be pushed into the shaft 4. The locking bar element 10 no longer prevents a movement of the flap 6, so that the flap 6 is pivoted about the flap axis 14, and thus frees the opening to the shaft 4. In the interior of the shaft 4, therefore, electrical contacts for producing a data connection or electrical connection may be present, said electrical contacts co-operating with corresponding interface elements on the receiving device 30.

If the part of the receiving device 30 is now removed again from the shaft 4, initially the flap 6 is pivoted by the flap spring 16 about the flap axis 14 into the position shown in FIG. 1. After the first interactive element 28 and the second interactive element 32 have again been moved away from one another, the carrier spring 26 forces the carrier element 22 again into the position shown in FIG. 1 and pivots the carrier element 22 about the carrier axis 24. As a result, the locking bar spring 20 is able to pivot the locking bar element 10 about the locking bar axis 18 so that the contact edge 12 of the locking bar element 10 again bears against the flap 6, as shown in FIG. 1. As a result, it is not necessary to operate a specific actuating element or to perform corresponding movements with one or other interactive element 28, 32, either for opening or closing the flap 6.

As soon as the part of the receiving device 30 which is able to be inserted into the shaft 4 is intended to be inserted into the shaft 4, the interaction between the first interactive element 28 and the second interactive element 32 ensures that the locking bar element 10 is moved from the closed position shown in FIG. 1 into the open position shown in FIG. 3 and thus the flap 6 may be opened.

When removing the receiving device 30 from the shaft, the situation shown in FIG. 1 is restored again so that the flap 6 may be closed again by the locking bar element 10 and not opened.

### LIST OF REFERENCE NUMERALS

2 Backrest
4 Shaft
6 Flap
8 Cover plate
10 Locking bar element
12 Contact edge
14 Flap axis
16 Flap spring
18 Locking bar axis
20 Locking bar spring
22 Carrier element
24 Carrier axis
26 Carrier spring
28 First interactive element
30 Receiving device
32 Second interactive element
34 Dashed lines

1. A retaining device for fastening an electronic device in a motor vehicle, wherein the retaining device has
a receiving device for receiving the electronic device and
a retainer with a shaft for inserting a part of the receiving device,
wherein the retainer has
a flap closing the shaft,
a first interactive element and
at least one locking bar element,
which is able to be moved into at least one closed position in which it prevents a movement of the flap,
and is able to be moved into an open position in which it does not prevent a movement of the flap,
wherein the receiving device has a second interactive element,
wherein the first interactive element and/or the second interactive element has a permanent magnet and
wherein the at least one locking bar element is able to be moved from the closed position into the open position, by the first interactive element and the second interactive element being brought together.

2. The retaining device according to claim 1, wherein the first interactive element or the second interactive element consist at least partially of a magnetizable material, in particular a paramagnetic or ferromagnetic material.

3. The retaining device according to claim 1, wherein at least one locking bar element is spring-loaded in the direction of the closed position.

4. The retaining device according to claim 1, wherein the first interactive element is arranged on a movably mounted carrier element which is arranged so that it moves the at least one locking bar element from the closed position into the open position when the first interactive element and the second interactive element are brought together.

5. The retaining device according to claim 4, wherein the carrier element is arranged on a side of the flap facing the shaft.

6. The retaining device according to claim 1, wherein at least one interface element is arranged in each case on the part of the receiving device which is able to be inserted into the shaft and in the shaft, such that the two interface elements come into contact with one another when the part of the receiving device is inserted into the shaft.

7. The retaining device according to claim 1, wherein the receiving device has an interface for producing an electrical connection and/or a data connection with the electronic device.

8. A retainer for the retaining device according to claim 1.

9. A motor vehicle comprising a retainer for the retaining device according claim 1.

10. A motor vehicle according to claim 9, wherein the retainer is arranged in a backrest of a motor vehicle seat.
